(19) United States
(12) Patent Application Publication
(10) Pub. No.: US 2003/0061401 A1
(43) Pub. Date: Mar. 27, 2003

(54) Input device virtualization with a programmable logic device of a server

(76) Inventor: Luis E. Luciani JR., Spring, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/963,016

(22) Filed: Sep. 25, 2001

(51) Int. Cl. G06F 9/00

(52) U.S. Cl. 709/324

(57) ABSTRACT

A server employs input device virtualization or emulation with a programmable logic device programmable by a virtual input device image and virtualization firmware. The programmable logic device acts as a virtual input device residing on a bus of the server. The virtualization firmware routes requests from an operating system to a remote real input device which returns the requested data to the operating system. As an example, the virtual input device may be a virtual CD-ROM drive or a virtual floppy drive. The programmable logic device may reside on a remote management card of the server.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to remote server management and more particularly to input device virtualization with a programmable logic device of a server.

2. Description of the Related Art

With the growing centralization of servers through data centers, remote server management is becoming increasingly important. A network administrator can manage multiple servers through a browser interface of a remote console that communicates with a remote management card of each server.

In the past, remote server management was limited by the need for configuring a server using a floppy drive of the server. For example, an operating system might be installed from a floppy diskette inserted into the floppy drive of the server. Thus, at one point in time, a network administrator had to visit the server for setup and installation.

More recently, server setup and installation has been accomplished remotely by using firmware to boot a server from a remote management card of the server which acts as a virtual floppy drive. While the actual floppy drive is at a remote client computer on the network, the floppy image is downloaded from the actual floppy drive to the remote management card. Floppy drive virtualization, which is performed in software, has allowed for both remote operating system installations and remote server read-only memory updates. This floppy drive virtualization technique, which has been employed in a past version of the Remote Insight Lights-Out Edition server management product of Compaq Computer Corporation, has largely eliminated the need for a network administrator to visit a server to insert a floppy diskette and boot the server. The virtual floppy drive, however, has depended upon communication by basic input output services (BIOS) with the remote management card in place of an actual floppy drive. As such, a virtual floppy drive has only been a viable option up until boot time of the server when BIOS is available. Another drawback of this virtual floppy drive technique is that it requires hooking an interrupt specific to a particular operating system (INT 15 in the case of a Microsoft Windows® operating system).

### BRIEF SUMMARY OF THE INVENTION

Briefly, a server employs input device virtualization or emulation with a programmable logic device programmable by a virtual input device image and virtualization firmware. The programmable logic device acts as a virtual input device residing on a bus of the server. The virtualization firmware routes requests from an operating system to a remote real input device which returns the requested data to the operating system. As an example, the virtual input device may be a virtual CD-ROM drive or a virtual floppy drive. The programmable logic device may reside on a remote management card of the server.

### BRIEF DESCRIPTION OF THE SEVERAL VIEWS OF THE DRAWINGS

FIG. 1 is a block diagram of a server employing a field programmable gate array (FPGA) and a FPGA controller in connection with input device virtualization or emulation.

FIG. 2 is a flow chart of an exemplary virtual input device loader relating to the FPGA of FIG. 1.

FIG. 3 is a flow chart of an exemplary virtual input device driver relating to the FPGA of FIG. 1.

FIG. 4 is a flow chart of an exemplary FPGA handling routine relating to the FPGA of FIG. 1.

FIG. 5 is a data flow diagram illustrating network communication in connection with input device virtualization or emulation relating to the FPGA of FIG. 1.

FIGS. 6A-6B illustrate exemplary PCI (Peripheral Component Interconnect) configuration registers of the FPGA of FIG. 1.

FIG. 7 is a table illustrating an exemplary file format for firmware image information before being programmed into the flash read-only memory of FIG. 1.

### DETAILED DESCRIPTION OF THE INVENTION

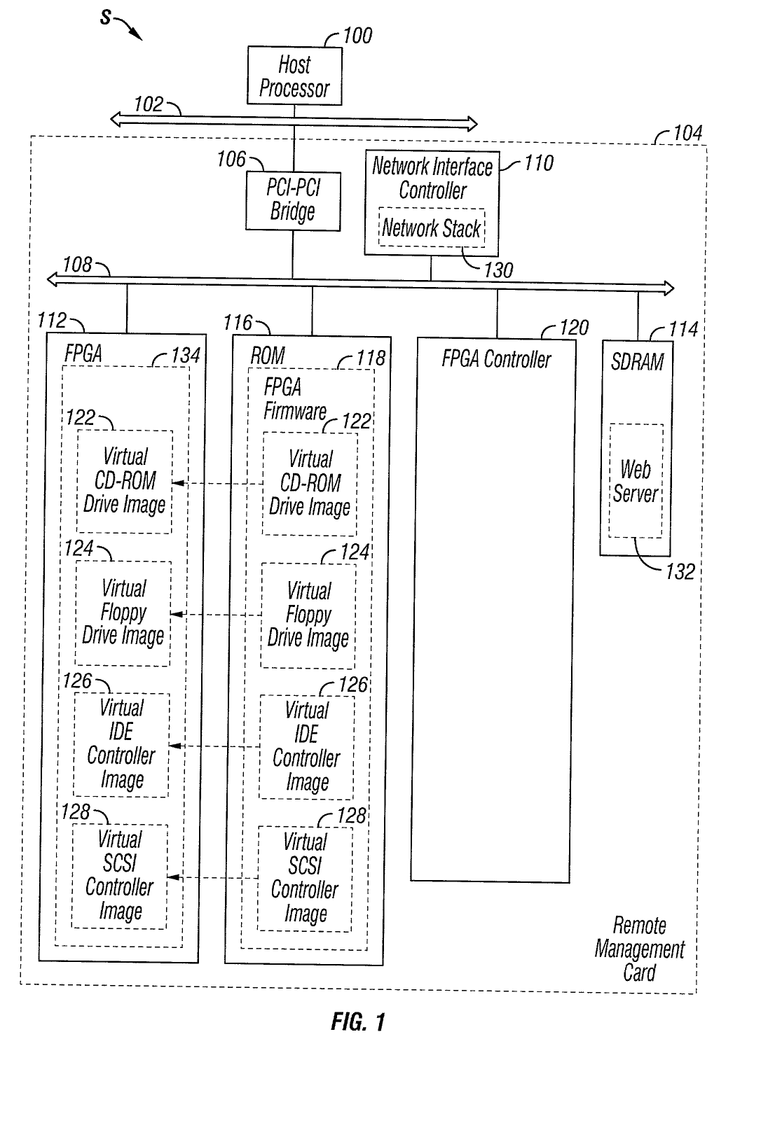

Turning now to the drawings, FIG. 1 shows a block diagram of an exemplary server S adapted for input device virtualization or emulation. The server S includes a system or host bus 102 coupled to a host processor 100. In an alternative embodiment, a plurality of host processors 100 can be coupled to the system bus 102 as servers commonly employ multiple processors. A remote management card 104 sits on the system bus 102, enabling remote management of the server S. The system bus 102 is coupled to a bridge 106, bridging the system bus 102 to a local bus 108 residing on the remote management card 104. The term “local bus” as used herein identifies a secondary peripheral or computer bus local to the remote management card 104 or more generally a peripheral or computer bus bridged to a primary or host bus of the server S. A suitable type of bus for serving as the system bus 102 and the local bus 108 is a Peripheral Component Interconnect (PCI) bus effectively compliant with the Peripheral Component Interconnect Bus Specification, Version 2.2 promulgated by the PCI Special Interest Group. For explanatory purposes, both the system bus 102 and the local bus 108 will be discussed as if implemented as a PCI bus. The remote management card 104 thus may be considered a PCI card. Similarly, the bridge 106 may be considered a PCI-PCI bridge. An example of a suitable PCI-PCI bridge for implementing the bridge 106 is the Intel 21152 PCI-PCI bridge.

The local bus 108 is coupled to a programmable logic device 112, a read-only memory (ROM) 116, a controller 120, a system memory 114 and a network interface controller (NIC) 110, each of which reside on the remote management card 104. As an example, the programmable logic device 112 can be a field programmable logic array (FPGA). One example of a suitable FPGA is the Xilinx Spartan-II array. The size of the FPGA 112 can be 4 MB or any other size sufficient to store virtual input device images 134. The ROM 116 can be a flash ROM. Virtualization firmware 118 including the virtual input device images 134 can be programmed into the flash ROM 116. The firmware 118 programs the FPGA 112 with the virtual input device images 134 which are firmware images that can be created using a standard FPGA tool and converted to an appropriate format, such as ‘C’ code, for programming into the flash ROM 116. Unlike typical firmware images, the virtual input device images 134 are designed to program the FPGA 112 to behave as virtual input devices. The NIC 110 implements a network stack 130, enabling network communication with the remote management card 104. This communication may be encrypted for security purposes. The system memory 114 includes a web server 132 for communicating with a network management application launched within a web browser or browser interface of a network administrator or other user. The system memory 114 can be implemented as a synchronous dynamic random access memory (SDRAM). The controller 120 controls the network stack 130, the web server 132, and execution of the firmware 118 which includes loading of the programmable logic device 112. The controller 120 thus serves as a controller for the programmable logic device 112. An example of a suitable controller for implementing the controller 120 is the IBM Power PC 405GP (PPC405GP) system-on-a-chip which includes a 32-bit reduced instruction set computer (RISC) embedded processor, a PCI interface, an Ethernet interface and other on-chip peripherals. The controller 120, however, can essentially be implemented with any processor. It should be understood that the term “controller” is to be construed to be inclusive of a processor.

As illustrated, the programmable logic device 112 can be loaded with the virtual input device images 134, enabling the programmable logic device 112 to act as a variety of input devices. Stated another way, the programmable logic device 112 serves as a programmable input device emulator. While FIG. 1 illustrates the virtual input device images 134 as loaded from the ROM 116, the images 134 can alternatively be loaded remotely to the programmable logic device 112 from over the Internet. The images 134 include a virtual CD-ROM drive image 122, a virtual floppy drive image 124, a virtual IDE controller image 126 and a virtual SCSI controller image 128. These images 134 provide the programmable logic device 112 the capability to emulate a CD-ROM drive, a floppy drive, an IDE controller and a SCSI controller. These types of input devices and controllers are only exemplary in that essentially any input device or controller can be emulated or virtualized. For input devices which cannot directly reside on the local bus 108, both the input device and the controller can be emulated. In that way, the emulated controller behaves as if it resides on the local bus 108 and the emulated input device behaves as if connected to the emulated controller. For example, to emulate an IDE floppy drive, both the IDE floppy drive and an IDE controller including a PCI interface or front end can be emulated. Any request or data relating to the emulated IDE floppy drive would therefore be routed through the emulated IDE controller. The emulated or virtual controller can either be a controller specifically for controlling the emulated input device or more generally can be a controller for controlling an emulated computer bus for communicating with the emulated input device. With the capability to emulate or virtualize an input device, the server S need not implement that type of input device. For example, the server S can be employed without a rotating media device such as a CD-ROM drive or a floppy drive if the server S includes the capability to emulate such a rotating media device. Thus, with the capability to emulate or virtualize any input device, the server S can appear to provide any input device. This capability is especially useful for input devices which are rarely used; such devices need not be implemented in the server S. By relying upon the virtualization or emulation capability of the server S to virtualize or emulate such devices when needed, the hardware of the server S may be optimized for the primary tasks handled by the server S.

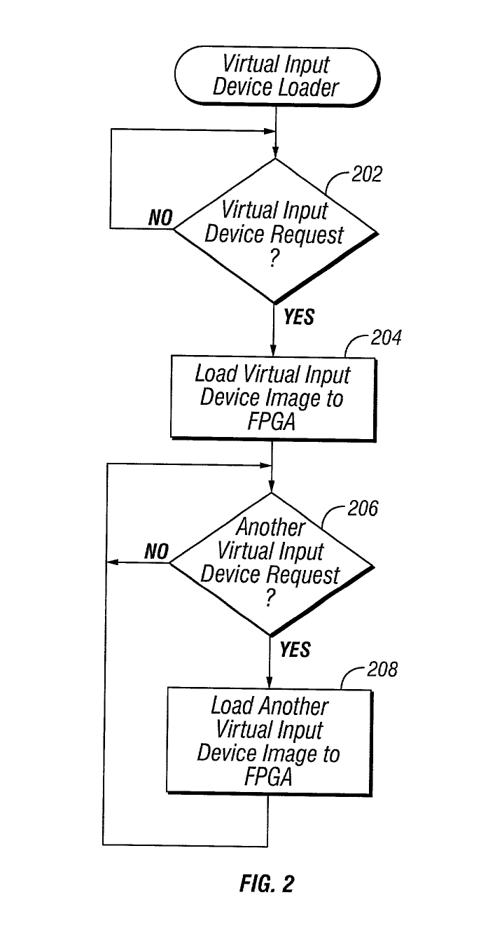

Referring to FIG. 2, a flow chart of an exemplary virtual input device loader run by the controller 120 early in the boot process of the server S is shown. Beginning in step 202, the loader determines if a virtual input device request has been received. A virtual input device request indicates the type of virtual device a network administrator or other user desires to “install” or load onto the server S. If a virtual input device request has not been received, the process remains in step 202. If a virtual input device request has been received, then the loader proceeds to step 204 where the virtual input device image corresponding to the virtual input device is loaded to the FPGA 112. For example, if the virtual input device request is a request for a virtual CD-ROM drive, then the virtual CD-ROM drive image 122 is loaded to the FPGA 112. If the virtual input device request is a request for an IDE floppy drive, then the virtual floppy drive image 124 and the virtual IDE controller 126 are loaded to the FPGA 112. If the Xilinx Spartan-II array is used as the FPGA 112, then a virtual input device image can loaded to the FPGA 112 in a “slave parallel” mode. The “slave parallel” mode of the Xilinx Spartan-II array is described at pages 16-18 in the Spartan-II 2.5V FPGA Family: Functional Description dated Mar. 5, 2001.

From step 204, the loader proceeds to step 206 where it is determined if a request for a different virtual input device has been received. If no such request has been received, then the loader remains in step 206. In this way, the loader can detect another request for a virtual input device during the boot process of the server S. The virtual input device request can be generated in response to a selection by a network administrator or other user for a virtual input device to be loaded to the server S. If a virtual input device request is detected in step 206, then the loader proceeds to step 208 in which the virtual input device image corresponding to the virtual input device request is loaded to the FPGA 112. Once loaded, the virtual input device image can be compressed until data is requested from the virtual input device. Since the virtual input device loader presents a capability to dynamically respond to a virtual input device request, the firmware 118 can be upgraded to add a virtual input device image at any time during the life of the remote management board 104. It should be understood that both the local bus 108 and the FPGA 112 have been configured prior to the steps shown for the virtual input device loader.

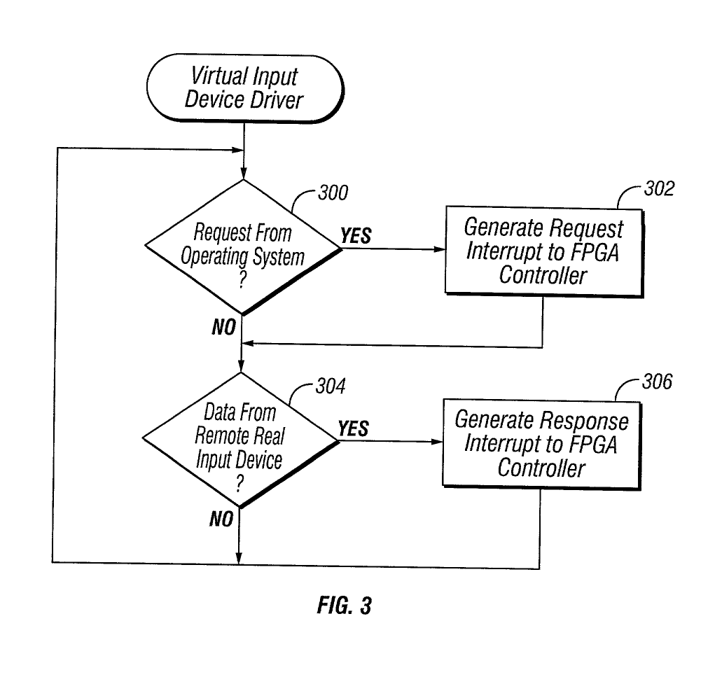

Referring to FIG. 3, a flowchart of an exemplary virtual input device driver is shown. This flowchart represents the device driver functionality handled by the FPGA 112 acting as a virtual input device. Beginning in step 300, it is determined if a virtual input device data request from an operating system run by the host processor 100 is detected. This is a data request is for data specifically associated with the type of input device being emulated or virtualized by the FPGA 112. An example of a suitable operating system is the Wind River VxWorks 5.4, a real time operating system. Alternatively, the data request may originate from an application or other software on the server S rather than directly from the operating system. If the firmware image for the virtual input device is compressed, the image can be decompressed in response to the data request.

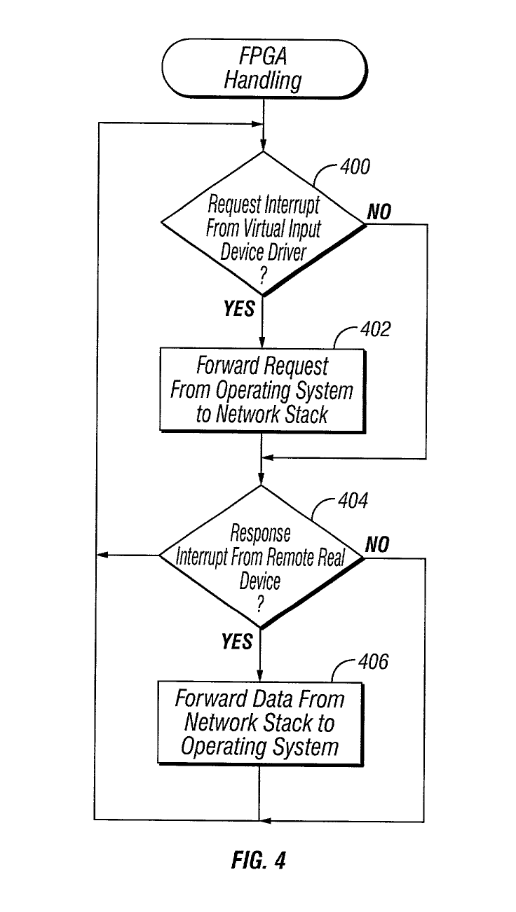

If a request is detected, the process proceeds to step 302 where a request interrupt is generated to the controller 120. As described below in connection with FIG. 4, the controller 120 responds by forwarding the data request over the network to a remote real input device corresponding to the virtual input device. To the requesting software, the virtual input device appears to be the real input device. The virtual input device thus is treated by the requesting software as a real input device. If a request is not detected in step 300, then control proceeds to step 304. In this step, it is determined if data has been received from the real input device. The process also arrives in step 304 following step 302. If data has been received, then a response interrupt is generated to the controller 120 in step 306. If data has not been received from the remote real input device, then the process returns to step 300. Following step 306, the process also returns to step 300. Since the process is continuous, data requests from software and data from the remote real input device may be detected and handled at any time.

Referring to FIG. 4, a flow chart of an exemplary FPGA handling process run by the controller 120 is shown. Beginning in step 400, it is determined if a request interrupt from the virtual input device driver is detected. If the request interrupt is detected, the process proceeds to step 402 where the data request from the operating system is forwarded to the network stack 130. Step 402 is followed by step 404 in which it is determined if a data response interrupt from the remote real input device is detected. The process also proceeds to step 404 from step 400 if an interrupt request is not detected. If a response interrupt is detected in step 404, then the data on the network stack 130 from the remote real input device is forwarded to the operating system or other requesting software. From step 406, the process is returned to step 400. In effect, the process treats the network or some device on the network as the actual or real input device being virtualized or emulated by the FPGA 112.

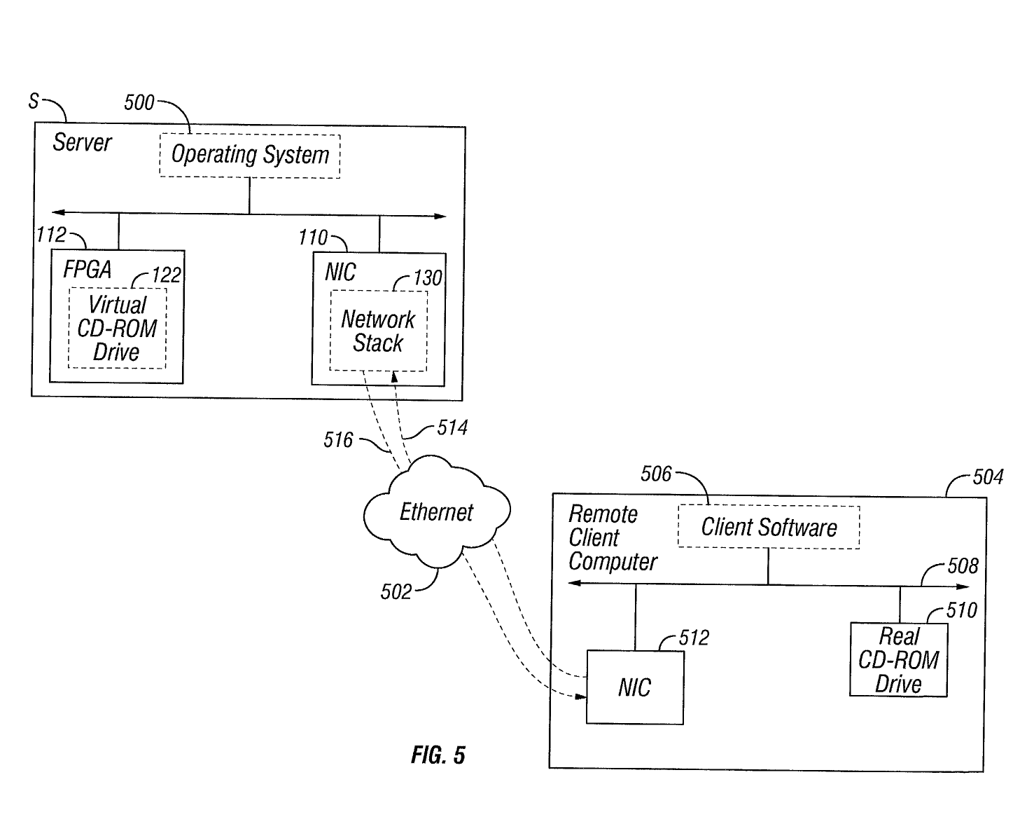

Referring to FIG. 5, an exemplary diagram for illustrating network communication associated with input device virtualization or emulation by the server S is shown. As illustrated, a data request 516 from an operating system 500 detected by the virtual CD-ROM drive 122 is communicated from the network stack 130 over Ethernet 502 to a network interface controller (NIC) 512 of a remote client computer 504. On the client computer 504, client software 506 processes the data request to locate the requested data on a real CD-ROM drive 510. The requested data 514 is then communicated over the Ethernet 502 to the network stack 130 on the server S. This communication over the Ethernet 502 with the real CD-ROM drive 510 is transparent to the operating system 500. To the operating system 500, the FPGA 112 appears to be the actual CD-ROM drive.

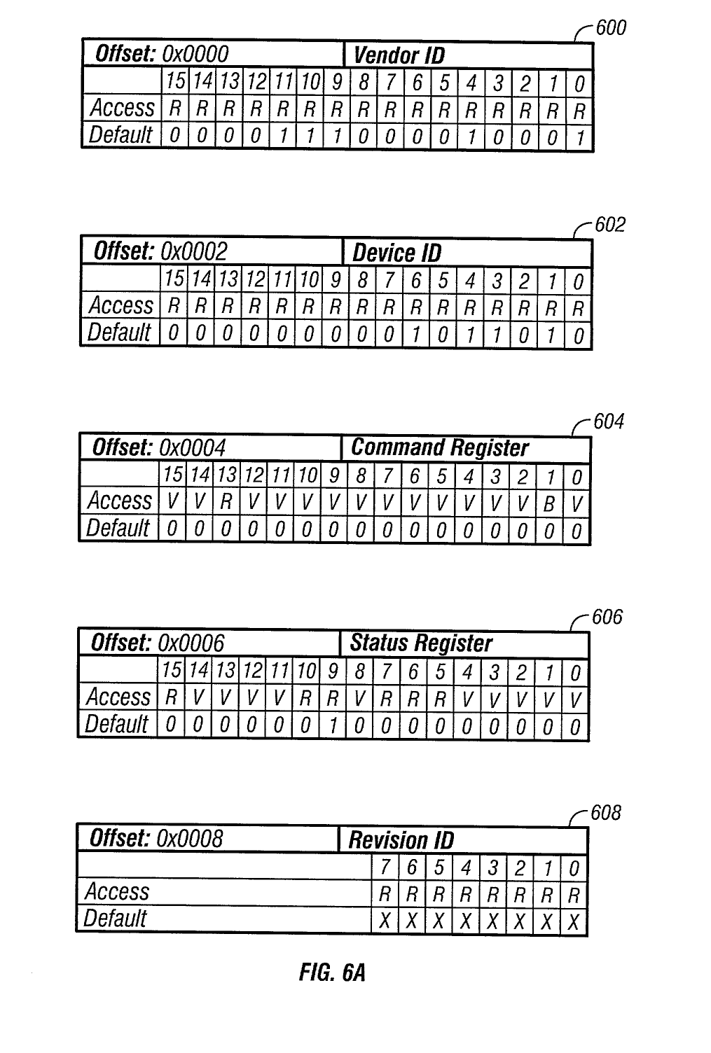

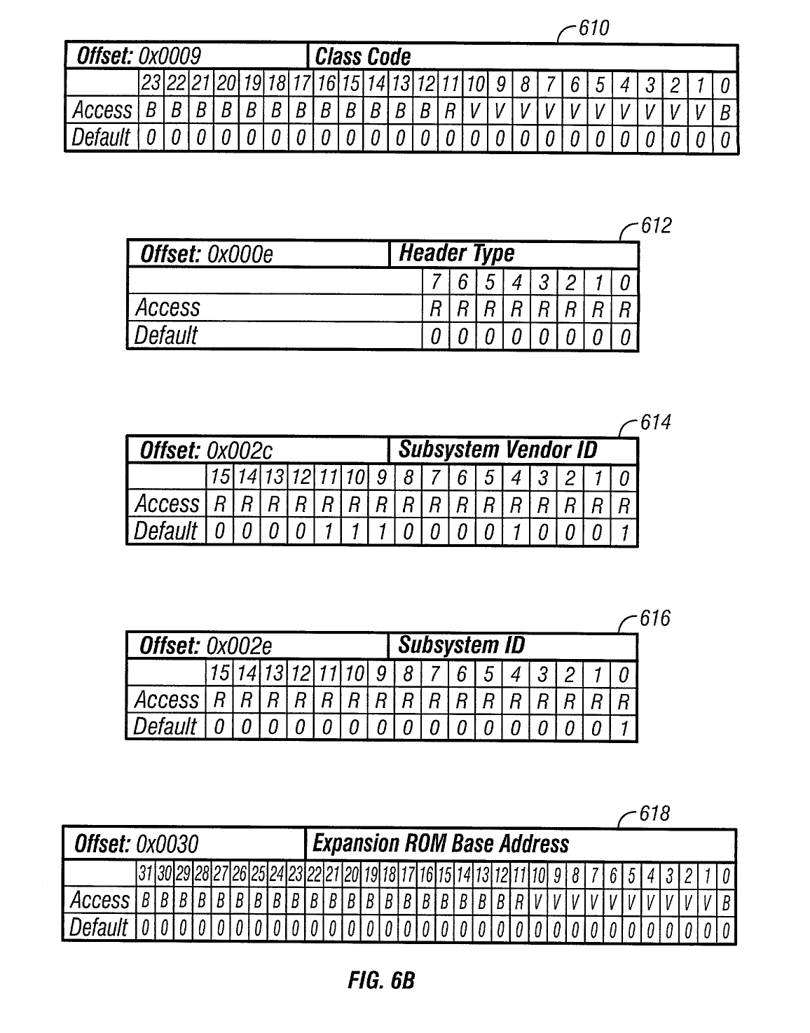

Referring to FIGS. 6A-6B, exemplary illustrations of PCI configuration registers of the controller 120 are shown. A vendor identification (ID) register 600 is a 16-bit register for storing the ID for the server vendor. On the access line of the vendor ID register 600, “R” indicates a read-only bit. A device ID register 602 is a 16-bit register for storing a device ID for the controller 120. A command register 604 is a 16-bit register for storing a memory access enable bit in the bit_1 position. When this bit is set, the controller 120 responds to PCI memory accesses. On the access line of the command register 604, as well as certain other illustrated PCI configuration registers, “V” indicates a reserved bit and “B” indicates a read-write bit. A status register 606 is a 16-bit register for storing a detect parity error bit in the bit_15 position, device select timing bits in the bit_10 and bit_9 position, a fast back-to-back capable bit in the bit_7 position, a user definable feature (UDF) support bit in the bit_6 position and a 66 MHz capable bit in the bit_5 position. Other bits of the status register 606 are reserved. The detect parity error bit is set whenever a parity error is detected. The device select timing bits define the slowest DEVSEL# timing for a target device with the exception of configuration accesses. The UDF support bit and the 66 MHz capable bit can be hardwired to zero since such functionality is not supported for the controller 120.

A revision ID register 608 is an 8-bit register storing a revision number for the controller 120. A class code register 610 is a 24-bit register for storing a class code and sub-class code for the controller 120. Bits 16-23 are used for the class code, and bits 8-15 are used for the sub-class code. Bits 0-7 are used for a programmable interface. A header type register 612 is an 8-bit register for storing header information. A subsystem vendor ID register 614 is a 16-bit register for storing a subsystem vendor ID for the server vendor. A subsystem ID register 616 is a 16-bit register storing a subsystem ID for the controller 120. An expansion ROM base address register 618 is a 32-bit register for storing an expansion ROM base address in bits 11-31 and an address decode enable in bit 0. Bits 1-10 are reserved. The setting of the expansion ROM base address determines the address range decoded by the controller 120. The address decode enable bit is set in order for the controller 120 to decode an address based on the expansion ROM base address. It should be understood that the PCI configuration registers illustrated are not exhaustive of the type of PCI configuration registers that can be provided in the controller 120.

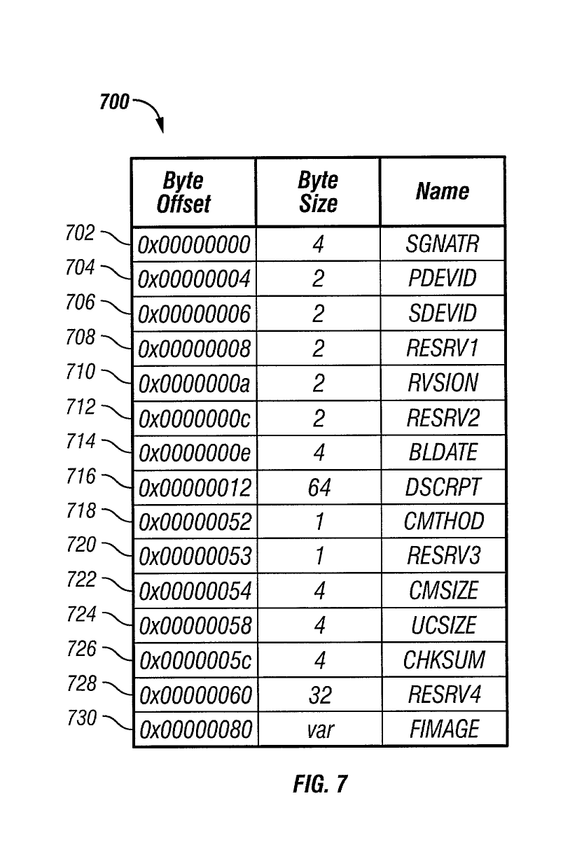

Referring to FIG. 7, a table illustrating an exemplary file format for firmware image information before being programmed into the flash ROM 116. A four-byte signature (SIGNATR) of the remote management card 104 is indicated by row 702. A two-byte PCI device ID (PDEVID) of the remote management card 104 is indicated by row 704. A two-byte PCI sub-device ID (SDEVID) of the remote management card is indicated by row 706. A two-byte location (RESERV1) reserved for other identification information is indicated by row 708. A two-byte revision code (RVSION) for the firmware image is indicated by row 710. A two-byte location (RESRV2) reserved for further revision information is indicated by row 712. A four-byte build date (BLDATE) for the firmware image is indicated by row 714. The first byte can represent the month; the second byte can represent the day; and the third and fourth bytes can represent the year. A sixty-four byte image description (DSCRPT) is indicated by row 716. For instance, if the firmware image is the virtual CD-ROM drive image 122, then the image description will relate to the virtual CD-ROM drive. The image description can be shown to the network administrator or other user before the image is flashed to the flash ROM 116.

A one-byte compression code (CMTHOD) is indicated by row 718. The code specifies whether compression is to be utilized for the firmware image. The code may also specify the type of compression. A one-byte location (RESRV3) indicated by row 720 is reserved. A four-byte compressed image size (CMSIZE) is indicated by row 722. If compression has been used, this information indicates the size of the firmware image. A four-byte uncompressed image size (UCSIZE) is indicated by row 724. When the image is uncompressed, this information indicates the size of the firmware image. A four-byte checksum (CHKSUM) is indicated by row 726. The 32-bit checksum value is used for verification of the firmware image. A checksum of zero can indicate that the firmware image is verified, enabling the image to be programmed into the flash ROM 116. A thirty-two byte location (RESRV4) indicated by row 728 is reserved. Row 730 (FIMAGE), the last row illustrated, represents the firmware image itself having a variable byte size.

The foregoing disclosure and description of the various embodiments are illustrative and explanatory thereof, and various changes in the controller, virtual input devices, buses, programmable logic device, remote management card, virtual input device images, virtual input device loader, virtual input device driver, programmable logic device handling routine, and the remote real input device, as well as in the details of the illustrated circuitry and software and construction and method of operation may be made without departing from the spirit and scope of the invention.

I claim:

1. A server, comprising:
a host processor;
a bus coupled to the host processor;
a memory coupled to the bus to store virtualization firmware;
a controller coupled to the bus to execute the virtualization firmware; and
a programmable logic device coupled to the bus and programmable by a virtual input device image and the virtualization firmware to generate a virtual input device on the bus.

2. The server of claim 1, wherein the programmable logic device generates a virtual controller for the virtual input device.

3. The server of claim 1, wherein the virtualization firmware routes requests from an operating system run by the host processor over a network to a real input device of a client computer and routes data responsive to the requests from the real input device to the operating system.

4. The server of claim 1, wherein the programmable logic device, the memory and the controller reside on a remote management card coupled to the bus.

5. The server of claim 1, wherein the programmable logic device comprises a field programmable gate array.

6. The server of claim 1, wherein the virtual input device appears to be a real input device to an operating system run by the host processor.

7. The server of claim 1, wherein the virtual input device comprises a virtual rotating media device.

8. The server of claim 7, wherein the virtual rotating media device comprises a virtual CD-ROM drive.

9. The server of claim 7, wherein the virtual rotating media device comprises a virtual floppy drive.

10. The server of claim 1, wherein the bus comprises a Peripheral Component Interconnect (PCI) bus.

11. A remote management card for connection to a bus of a server, the card comprising:
a memory to store virtualization firmware;
a controller to execute the virtualization firmware; and
a programmable logic device programmable by a virtual input device image and the virtualization firmware to generate a virtual input device on a bus of a server.

12. The remote management card of claim 11, wherein the programmable logic device generates a virtual controller for the virtual input device.

13. The remote management card of claim 12, wherein the virtualization firmware routes requests to a remote real input device of a client computer and routes data from the real input device.

14. The remote management card of claim 11, wherein the virtual input device comprises a virtual rotating media device.

15. The remote management card of claim 11, wherein the programmable logic device comprises a field programmable gate array.

16. The remote management card of claim 11, further comprising:
a network interface for remote network communication by the server to a remote real input device corresponding to the virtual input device.

17. The remote management card of claim 11, wherein the bus comprises a Peripheral Component Interconnect (PCI) bus.

18. A method of input device virtualization for a server, comprising the steps of:
loading a virtual input device image for a programmable logic device on a bus of a server; and
programming the programmable logic device with the virtual input device image to generate a virtual input device on the bus.

19. The method of claim 18, further comprising the step of:
programming the programmable logic device with the virtual input device image to generate a virtual controller for the virtual input device.

20. The method of claim 18, wherein the virtual input device is generated by performing the steps of:
routing requests from an operating system of the server over a network to a remote real input device; and
routing data from the remote real input device over the network to the operating system.

21. The method of claim 18, wherein the virtual input device comprises a virtual rotating media device.

22. The method of claim 18, wherein the programmable logic device comprises a field programmable gate array.

23. The method of claim 18, wherein the server comprises a server without a real rotating media device.

24. The method of claim 18, wherein the bus comprises a Peripheral Component Interconnect (PCI) bus.

25. A method of input device emulation for a server, comprising the steps of:
loading an image to a programmable logic device on a bus of a server; and
programming the programmable logic device with the image to emulate an input device on the bus.

26. The method of claim 25, wherein the input device is emulated by routing requests from an operating system of the server over a network to a remote real input device and routing data from the remote real input device over the network to the operating system.

27. The method of claim 25, wherein the input device comprises a rotating media device.

28. The method of claim 25, wherein the programmable logic device comprises a field programmable logic array.

29. The method of claim 25, wherein the server comprises a server without a real rotating media device.

30. The method of claim 25, wherein the bus comprises a Peripheral Component Interconnect (PCI) bus.
